(19) United States
(12) Patent Application Publication
(10) Pub. No.: US 2010/0296598 A1
(43) Pub. Date: Nov. 25, 2010

(54) SORTED QR DECOMPOSITION METHOD USED IN DETECTION OF MIMO ANTENNA SYSTEM AND DETECTOR USING THE SAME

(75) Inventors: Wei-Ting Li, Tainan City (TW); Cheng-Ming Chen, Hsinchu City (TW); Ren-Hao Lai, Yilan County (TW); Yuan-Hao Huang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/553,102

(22) Filed: Sep. 3, 2009

(30) Foreign Application Priority Data
May 22, 2009 (TW) 98117178

(51) Int. Cl. H04B 7/02

(52) U.S. Cl. 375/267

(57) ABSTRACT

A sorted QR decomposition method used in a detection of a multiple input multiple output (MIMO) communication system is provided. First, whether a sorting-stop parameter of a channel transformation matrix of the MIMO communication system is greater than or equal to a sorting-stop threshold is determined. Then, whether energy of elements in a leftmost column within a process area of the channel transformation matrix is completely transferred to a top element in the leftmost column is determined. If the energy of the elements in the leftmost column within the process area is not yet completely transferred to the top element in the leftmost column, a unit process area of a process unit set is expanded.

### CROSS-REFERENCE TO RELATED APPLICATION

This application claims the priority benefit of Taiwan application serial no. 98117178, filed on May 22, 2009. The entirety of the above-mentioned patent application is hereby incorporated by reference herein and made a part of specification.

1. Technical Field

The present invention generally relates to a method used in a detection of a multiple input multiple output (MIMO) antenna system, and more particularly, to a sorted QR decomposition method used in a detection of a MIMO antenna system and a detector using the same.

2. Background

Presently, multiple input multiple output (MIMO) technique is broadly applied in wireless communication systems. For example, both a 3GPP-LTE system and a Worldwide Interoperability for Microwave Access (WiMAX) system based on the IEEE 802.16 standard adopt the MIMO technique along with an orthogonal frequency division multiplex (OFDM) technique.

FIG. 1 is a schematic diagram of a conventional MIMO wireless communication system. FIG. 1 illustrates a plurality of transmit antennas in a transmitter and a plurality of receive antennas in a receiver of a wireless communication system adopting the MIMO technique. Referring to FIG. 1, the MIMO wireless communication system 100 has a transmitter 110 and a receiver 120. The transmitter 110 has K transmit antennas 112, and the receiver 120 has L receive antennas 122. Theoretically, K and L are positive integers, and K and L may have different values. The transmitter 110 of the MIMO wireless communication system 100 receives a data stream (not shown). After processing the data stream through space time coding (not shown), the transmitter 110 appropriately distributes the data stream to the K transmit antennas 112, so as to transmit the data stream to the receiver 120 through wireless transmission. The data stream is received by the receiver 120 through the L receiver antennas 122 thereof and restored through an appropriate detection algorithm (not shown) and subsequent decoding processes (not shown). As shown in FIG. 1, the channel transformation matrix 130 shows an one-to-one correspondence between the transmit antennas 112 of the transmitter 110 and the receive antennas 122 of the receiver 120. This one-to-one correspondence relationship will be described below.

Conventionally, the transmission signal (not shown) transmitted by the transmitter 110 of the MIMO wireless communication system 100 through the K transmit antennas 112 thereof to the receiver 120 can be expressed with following equation (1):

$$\tilde{S} = [ \begin{matrix}{S}_{1} \\ {S}_{2} \\ ⋮ \\ {S}_{K}\end{matrix} ] \qquad Equation ( 1 )$$

In foregoing equation (1), vector S is a K×1 vector, and each element in the vector S represents a symbol transmitted by the transmitter 110 through one of the K transmit antennas 112.

The transmission signal (not shown) received by the L receive antennas 122 of the receiver 120 of the MIMO wireless communication system 100 can be expressed with following equation (2):

$$\tilde{R} = [ \begin{matrix}{R}_{1} \\ {R}_{2} \\ ⋮ \\ {R}_{L}\end{matrix} ] \qquad Equation ( 2 )$$

In foregoing equation (2), vector R is an L×1 vector, and each element in the vector R represents a symbol received by the receiver 120 through one of the L receive antennas 122.

Conventionally, the one-to-one correspondence between the transmit antennas 112 and the receive antennas 122 of the MIMO wireless communication system 100 can be expressed with following equation (3):

\tilde{Y}=\tilde{H}•\tilde{S}+Ñ Equation (3)

In foregoing equation (3), matrix H is a L×K matrix (i.e., the channel transformation matrix 130 illustrated in FIG. 1) and which represents the one-to-one correspondence between the transmit antennas 112 of the transmitter 110 and the receive antennas 122 of the receiver 120. Vector N is a L×1 vector and represents predictive values of noise respectively received by the L receive antennas 122 of the receiver 120. The calculation between the matrix H and the vector S in foregoing equation (3) is a matrix multiplication. To be more specific, the matrix H can be expressed with following equation (4):

$$\tilde{H} = [ \begin{matrix}{h}_{11} & {h}_{12} & … & {h}_{1 K} \\ {h}_{21} & {h}_{22} & … & {h}_{2 K} \\ ⋮ & ⋮ & ⋱ & ⋮ \\ {h}_{L 1} & {h}_{L 2} & … & {h}_{LK}\end{matrix} ] \qquad Equation ( 4 )$$

As described above, the matrix H is an L×K matrix (i.e., the channel transformation matrix 130 illustrated in FIG. 1). Elements of the matrix H (referred to as the channel transformation matrix H thereinafter) represent the one-to-one correspondence between the transmit antennas 112 of the transmitter 110 and the receive antennas 122 of the receiver 120. For example, the element h₁₁ represents a channel response parameter between the first transmit antenna 112 of the transmitter 110 and the first receive antenna 122 of the receiver 120, and the element h_{2K} represents a channel response parameter between the K^{th} transmit antenna 112 of the transmitter 110 and the second receive antenna 122 of the receiver 120. Besides, the K transmit antennas 112 of the transmitter 110 periodically (or when a predetermined condition is satisfied) transmit a constant training sequence to the L receive antennas 122 of the receiver 120, so as to obtain the channel response parameter between each of the transmit antennas 112 and each of the receive antennas 122 in the foregoing matrix H.

Conventionally, in a MIMO communication system, a determinant calculation of an inverse matrix of the channel transformation matrix H is simplified through QR decomposition (QRD) in order to detect the symbols transmitted by the transmit antennas 112 of the transmitter 110. The decomposed channel transformation matrix H can be expressed with following equation (5):

\tilde{H}=\tilde{Q}•\tilde{R} Equation (5)

In foregoing equation (5), matrix Q is an L×K identity matrix, and matrix R is a K×K upper triangular matrix. Determinants of the channel transformation matrix H are quickly obtained through the QR decomposition, and an inverse matrix H⁻¹ of the channel transformation matrix H is then calculated. Eventually, the symbols transmitted by the transmitter to the receiver are detected according to the calculated inverse matrix H⁻¹.

In addition, a sorted QR decomposition (SQRD) method is provided in order to efficiently detect the symbols transmitted by the transmitter to the receiver, wherein a channel processing order in a detection algorithm of the receiver of a MIMO communication system is optimized. However, calculations of the sorted QR decomposition method become very complicated when the number of antennas in the transmitter or the receiver is increased or even when a great number of OFDM subcarriers are used in a wireless communication system. Therefore, effective reduction of calculation time and the number of sorting in the sorted QR decomposition method is a major subject to a MIMO wireless communication system.

### SUMMARY

According to an exemplary embodiment consistent with the present disclosure, a sorted QR decomposition method used in a detection of a multiple input multiple output (MIMO) communication system is provided. The MIMO communication system has a channel transformation matrix. A receiver of the MIMO communication system receives a predetermined training sequence from a transmitter of the MIMO communication system to obtain a channel transformation matrix. The channel transformation matrix has a plurality of elements, wherein each of the elements in the channel transformation matrix represents a channel response parameter between one of a plurality of transmit antennas and one of a plurality of transmit antennas. The receiver has a plurality of processing units. The sorted QR decomposition method includes following steps. First, whether a sorting-stop parameter of the channel transformation matrix is greater than or equal to a sorting-stop threshold is determined, wherein the sorting-stop parameter is a sum of the number of all rows within a first process area that the energy of the elements in these rows is to be transferred to a diagonal element of the channel transformation matrix. Then, whether energy of the elements in a leftmost column within a second process area is completely transferred to a top element in the leftmost column is determined. If the energy of the elements in the leftmost column within the second process area is not yet completely transferred to the top element in the leftmost column, a unit process area of a first processing unit set in the processing units is expanded in the leftmost column within the second process area of the channel transformation matrix.

According to an exemplary embodiment consistent with the present disclosure, a computer-readable storage medium for storing a program is provided, wherein the program executes the sorted QR decomposition method described above.

According to an exemplary embodiment consistent with the present disclosure, a sorted QR decomposition method used in a detection of a MIMO communication system is also provided. A receiver of the MIMO communication system receives a predetermined training sequence from a transmitter to obtain a channel transformation matrix. The channel transformation matrix has a plurality of elements, wherein each of the elements in the channel transformation matrix represents a channel response parameter between one of a plurality of transmit antennas and one of a plurality of transmit antennas. The receiver has a plurality of processing units. The sorted QR decomposition method includes following steps. First, whether a sorting-stop parameter of the channel transformation matrix is greater than or equal to a sorting-stop threshold is determined. Next, if the sorting-stop parameter of the MIMO communication system is greater than or equal to the sorting-stop threshold, a process area is contracted by one row and one column toward a bottom right corner. If the sorting-stop parameter of the MIMO communication system is less than the sorting-stop threshold, whether all the columns within the process area are sorted is determined.

According to an exemplary embodiment consistent with the present disclosure, a sorted QR decomposition method used in a detection of a MIMO communication system is further provided. A receiver of the MIMO communication system receives a predetermined training sequence from a transmitter to obtain a channel transformation matrix. The channel transformation matrix has a plurality of elements, wherein each of the elements in the channel transformation matrix represents a channel response parameter between one of a plurality of transmit antennas and one of a plurality of transmit antennas. The receiver has a plurality of processing units. The sorted QR decomposition method includes following steps. First, whether a sorting-stop parameter is greater than or equal to a sorting-stop threshold is determined. Next, whether the energy of the elements in a leftmost column within a first process area is completely transferred to the top element in the leftmost column is determined. If the energy of the elements in the leftmost column within the first process area is not yet completely transferred to the top element in the leftmost column, a unit process area of a first processing unit set is expanded in the leftmost column within the first process area of the channel transformation matrix.

According to an exemplary embodiment consistent with the present disclosure, a MIMO detector using a QR decomposition method is provided, wherein the MIMO detector is used in a detection of a MIMO communication system. The MIMO communication system has a channel transformation matrix, a transmitter, and a receiver. The channel transformation matrix has a plurality of elements, wherein each of the elements in the channel transformation matrix represents a channel response parameter between one of a plurality of transmit antennas and one of a plurality of transmit antennas. The MIMO detector includes a plurality of processing units, a sorting-stop parameter generating unit, a sorting-stop threshold generating unit, a sorting-stop determination unit, a memory, and a processor. The processing units perform at least a sorting action and an energy transferring action to the channel transformation matrix, and the processing units are grouped into a first processing unit set and a second processing unit set. The sorting-stop parameter generating unit generates a sorting-stop parameter, wherein the sorting-stop parameter is a sum of the number of all rows within a first process area of the channel transformation matrix that energy of the elements in these rows is to be transferred to a diagonal element of the channel transformation matrix. The sorting-stop threshold generating unit calculates a sorting-stop threshold according to the equation X=(N−i)/2, wherein X is the sorting-stop threshold, N is the number of rows of the channel transformation matrix, and i is the index of a column in the channel transformation matrix to which the energy transferring action is currently performed. The sorting-stop determination unit determines whether the sorting-stop parameter of the channel transformation matrix is greater than or equal to the sorting-stop threshold. The memory records the sorting-stop parameter, the sorting-stop threshold, the elements within a first process area, the elements within the second process area, and the elements of the channel transformation matrix. The processor executes the sorting-stop parameter generating unit, the sorting-stop threshold generating unit, and the sorting-stop determination unit, and the processor moves the processing units between the first processing unit set and the second processing unit set.

According to an exemplary embodiment consistent with the present disclosure, a MIMO detector using a QR decomposition method is provided, wherein the MIMO detector is used in a detection of a MIMO communication system. The MIMO communication system has a channel transformation matrix, a transmitter, and a receiver. The channel transformation matrix has a plurality of elements, wherein each of the elements in the channel transformation matrix represents a channel response parameter between one of a plurality of transmit antennas and one of a plurality of transmit antennas. The MIMO detector includes a plurality of processing units, a sorting-stop parameter generating unit, a sorting-stop threshold generating unit, a sorting-stop determination unit, a memory, and a processor. The processing units of the detector perform at least a sorting action and an energy transferring action to the channel transformation matrix, and the processing units are grouped into a first processing unit set and a second processing unit set. The sorting-stop parameter generating unit generates a sorting-stop parameter. The sorting-stop threshold generating unit generates a sorting-stop threshold. The sorting-stop determination unit determines whether the sorting-stop parameter of the channel transformation matrix is greater than or equal to the sorting-stop threshold. The memory records the sorting-stop parameter, the sorting-stop threshold, the elements within a first process area, the elements within a second process area, and the elements of the channel transformation matrix. The processor executes the sorting-stop parameter generating unit, the sorting-stop threshold generating unit, and the sorting-stop determination unit, and the processor moves the processing units between the first processing unit set and the second processing unit set.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of a conventional multiple input multiple output (MIMO) wireless communication system.

FIG. 2 is a system block diagram of a MIMO detector using a sorted QR decomposition method according to an exemplary embodiment.

FIG. 3 is a flowchart of a sorted QR decomposition method according to the exemplary embodiment.

FIG. 4A-FIG. 4I illustrate the processing states of a sorted QR decomposition method with idle processing units in a channel transformation matrix.

FIG. 5A-FIG. 5C illustrate the processing states of a sorted QR decomposition method without idle processing unit in a channel transformation matrix.

FIG. 6 is a system block diagram of a MIMO detector using a sorted QR decomposition method according to another exemplary embodiment.

FIG. 7 is a flowchart of a sorted QR decomposition method according to the exemplary embodiment.

FIG. 8 is a system block diagram of a MIMO detector using a sorted QR decomposition method according to an exemplary embodiment.

FIG. 9 is a flowchart of a sorted QR decomposition method according to the exemplary embodiment.

FIG. 10 is a flowchart of a sorted QR decomposition method according to an exemplary embodiment.

FIG. 11 is a flowchart of a sorted QR decomposition method according to an exemplary embodiment.

### DESCRIPTION OF THE EMBODIMENTS

Reference will now be made in detail to the present exemplary embodiments of the invention, examples of which are illustrated in the accompanying drawings. Wherever possible, the same reference numbers are used in the drawings and the description to refer to the same or like parts.

According to exemplary embodiments consistent with the present disclosure, a sorted QR decomposition method used in a detection of a multiple input multiple output (MIMO) antenna system is provided, wherein energy required by a QR decomposition, the current signal-to-noise ratio (SNR) value of the MIMO communication system, and the eigenvalue spread of a channel transformation matrix are used as sorting-stop thresholds in the QR decomposition.

According to an exemplary embodiment consistent with the present disclosure, a sorted QR decomposition method used in a detection of a MIMO communication system is provided. The MIMO communication system has a channel transformation matrix. A receiver of the MIMO communication system receives a predetermined training sequence from a transmitter of the MIMO communication system to obtain the channel transformation matrix. The channel transformation matrix has a plurality of elements, wherein each of the elements in the channel transformation matrix represents a channel response parameter between one of a plurality of transmit antennas and one of a plurality of transmit antennas. The receiver has a plurality of processing units. The sorted QR decomposition method includes following steps. First, whether a sorting-stop parameter of the channel transformation matrix is greater than or equal to a sorting-stop threshold is determined, wherein the sorting-stop parameter is a sum of the number of rows within a first process area that energy of the elements in the rows is to be transferred to a diagonal element of the channel transformation matrix. Then, whether energy of the elements in a leftmost column within a second process area is completely transferred to the top element in the leftmost column is determined. If the energy of the elements in the leftmost column within the second process area is not yet completely transferred to the top element in the leftmost column, a unit process area of a first processing unit set in the processing units is expanded in the leftmost column within the second process area of the channel transformation matrix.

According to an exemplary embodiment consistent with the present disclosure, the sorted QR decomposition method further includes following steps. First, if the sorting-stop parameter within the first process area is less than the sorting-stop threshold, whether all the columns within the first process area are sorted is determined. If the sorting-stop parameter within the first process area is greater than or equal to the sorting-stop threshold, the first process area is contracted toward the bottom right corner of the first process area.

According to an exemplary embodiment consistent with the present disclosure, in the sorted QR decomposition method, whether the first processing unit set has reached the element at the bottom right corner of the channel transformation matrix is further determined, wherein if the first processing unit set has not reached the element at the bottom right corner of the channel transformation matrix, the second process area is contracted toward the bottom right corner of the second process area.

According to an exemplary embodiment consistent with the present disclosure, in the sorted QR decomposition method, whether all columns within the first process area are sorted is further determined after the first process area is contracted toward the bottom right corner thereof. If all the columns within the first process area have been sorted, a sorting action is performed within the first process area through the second processing unit set according to a norm of each of the columns within the first process area, wherein the sorting action is performed within the second process area through the first processing unit set if the second processing unit set is an empty set. If not all the columns within the first process area are sorted, an energy transferring action is performed to the leftmost column within the second process area through each processing unit in the first processing unit set, and meanwhile, the energy transferring action is performed to a second leftmost column within the second process area, and the sorting action is performed within the first process area through the second processing unit set according to a norm of each of the columns within the first process area.

According to an exemplary embodiment consistent with the present disclosure, in the sorted QR decomposition method, the sorting action includes sorting all the columns according to the norm of each of the columns, wherein the column having the smallest norm is arranged as the leftmost column, and the column having the greatest norm is arranged as the rightmost column.

According to an exemplary embodiment consistent the present disclosure, in the sorted QR decomposition method, the transmitter of the MIMO communication system has K transmit antennas and L receive antennas, wherein K and L are both positive integers, and the channel transformation matrix is a L×K matrix. The channel transformation matrix has L rows and K columns, and each element in the channel transformation matrix represents a channel response parameter between one of the K transmit antennas and one of the L receive antennas.

According to an exemplary embodiment consistent the present disclosure, in the sorted QR decomposition method, the first process area of the channel transformation matrix originally includes all the elements of the channel transformation matrix, and the second process area of the channel transformation matrix originally includes all elements in a bottom left triangular area of the channel transformation matrix.

According to an exemplary embodiment consistent the present disclosure, the sorted QR decomposition method further includes following steps. When one of the processing units in the first processing unit set is idle, the idle processing unit is moved to the second processing unit set. When there is just one processing unit in the first processing unit set and the energy of the elements in the leftmost column within the first process area has been completely transferred to the top element in the leftmost column, all the processing units in the second processing unit set are moved to the first processing unit set.

According to an exemplary embodiment consistent with the present disclosure, in the sorted QR decomposition method, the sorting-stop threshold is obtained through the equation X=(N−i)/2, wherein X is the sorting-stop threshold, N is the sum of the number of all rows of the channel transformation matrix, and i is the index of a column in the channel transformation matrix to which the energy transferring action is currently performed.

According to an exemplary embodiment consistent with the present disclosure, a computer-readable storage medium for storing a program is provided, wherein the program executes the sorted QR decomposition method described above.

According to an exemplary embodiment consistent with the present disclosure, a sorted QR decomposition method used in a detection of a MIMO communication system is provided. A server of the MIMO communication system receives a predetermined training sequence from a transmitter to obtain a channel transformation matrix. The channel transformation matrix has a plurality of elements, wherein each of the elements in the channel transformation matrix represents a channel response parameter between one of a plurality of transmit antennas and one of a plurality of transmit antennas. The receiver has a plurality of processing units. The sorted QR decomposition method includes following steps. First, whether a sorting-stop parameter of the channel transformation matrix is greater than or equal to a sorting-stop threshold is determined. Then, if the sorting-stop parameter of the MIMO communication system is greater than or equal to the sorting-stop threshold, a sorting action is performed to all columns within a process area through the processing units according to a norm of each of the columns within the process area. On the other hand, if the sorting-stop parameter of the MIMO communication system is less than the sorting-stop threshold, energy of the elements in a leftmost column within a unit process area of the processing units is transferred to another element in the same column.

According to an exemplary embodiment consistent with the present disclosure, in the sorted QR decomposition method, the sorting-stop parameter is a signal-to-noise ratio (SNR) value of the MIMO communication system, and the SNR value is obtained according to a pilot signal with a constant signal strength received by the receiver from the transmitter. Besides, when the sorting-stop parameter is the SNR value, the sorting-stop threshold is a predetermined SNR threshold.

According to an exemplary embodiment consistent with the present disclosure, in the sorted QR decomposition method, the sorting-stop parameter is an eigenvalue spread value. The eigenvalue spread value represents the spread of a plurality of eigenvalues of the channel transformation matrix in the MIMO communication system, and the eigenvalue spread value is also a variance of the eigenvalues of the channel transformation matrix. When the sorting-stop parameter is the eigenvalue spread value, the sorting-stop threshold is a predetermined eigenvalue spread threshold, and the sorting-stop threshold is greater than 0.

According to an exemplary embodiment of the present disclosure, a computer-readable storage medium for storing a program is provided, wherein the program executes the sorted QR decomposition method described above with the sorting-stop parameter as the SNR of the MIMO communication system.

According to an exemplary embodiment consistent with the present disclosure, a computer-readable storage medium for storing a program is provided, wherein the program executes the sorted QR decomposition method described above with the sorting-stop parameter as an eigenvalue spread value.

According to an exemplary embodiment consistent with the present disclosure, a sorted QR decomposition method used in a detection of a MIMO communication system is provided. A receiver of the MIMO communication system receives a predetermined training sequence from a transmitter to obtain a channel transformation matrix. The channel transformation matrix has a plurality of elements, wherein each of the elements represents a channel response parameter between one of a plurality of transmit antennas and one of a plurality of transmit antennas. The receiver has a plurality of processing units. The sorted QR decomposition method includes following steps. First, whether a sorting-stop parameter within a first process area is greater than or equal to a sorting-stop threshold is determined. Then, whether energy of the elements in a leftmost column within the first process area has been completely transferred to the top element in the leftmost column is determined. If energy of the elements in the leftmost column within the first process area has not been completely transferred to the top element in the leftmost column, a unit process area of a first processing unit set in the processing units is expanded in the leftmost column within a second process area of the channel transformation matrix.

According to an exemplary embodiment consistent with the present disclosure, a MIMO detector using a QR decomposition method is provided, wherein the MIMO detector is used in a detection of a MIMO communication system. The MIMO communication system has a channel transformation matrix, a transmitter, and a receiver. The channel transformation matrix has a plurality of elements, wherein each of the elements in the channel transformation matrix represents a channel response parameter between one of a plurality of transmit antennas and one of a plurality of transmit antennas. The detector includes a plurality of processing units, a sorting-stop parameter generating unit, a sorting-stop threshold generating unit, a sorting-stop threshold generating unit, a sorting-stop determination unit, a memory, and a processor. The processing units performs at least a sorting action and an energy transferring action to the channel transformation matrix, and these processing units are grouped into a first processing unit set and a second processing unit set. The sorting-stop parameter generating unit generates a sorting-stop parameter, wherein the sorting-stop parameter is a sum of the number of rows within a second process area of the channel transformation matrix energy of elements in these rows is to be transferred to a diagonal element of the channel transformation matrix. The sorting-stop threshold generating unit obtains a sorting-stop threshold through an equation X=(N−i)/2, wherein X is the sorting-stop threshold, N is the row number of the channel transformation matrix, and i is the index of a column in the channel transformation matrix to which the energy transferring action is currently performed. The sorting-stop determination unit determines whether the sorting-stop parameter of the channel transformation matrix is greater than or equal to the sorting-stop threshold. The memory records at least the sorting-stop parameter, the sorting-stop threshold, elements within the first process area, elements within the second process area, and the elements of the channel transformation matrix. The processor executes at least the sorting-stop parameter generating unit, the sorting-stop threshold generating unit, and the sorting-stop determination unit and moves the processing units between the first processing unit set and the second processing unit set.

According to an exemplary embodiment consistent with the present disclosure, a MIMO detector using a QR decomposition method is provided, wherein the MIMO detector is used in a detection of a MIMO communication system. The MIMO communication system has a channel transformation matrix, a transmitter, and a receiver. The channel transformation matrix has a plurality of elements, wherein each of the elements in the channel transformation matrix represents a channel response parameter between one of a plurality of transmit antennas and one of a plurality of transmit antennas. The detector includes a plurality of processing units, a sorting-stop parameter generating unit, a sorting-stop threshold generating unit, a sorting-stop determination unit, a memory, and a processor. The processing units performs at least a sorting action and an energy transferring action to the channel transformation matrix, and these processing units are grouped into a first processing unit set and a second processing unit set. The sorting-stop parameter generating unit generates a sorting-stop parameter. The sorting-stop threshold generating unit generates a sorting-stop threshold. The sorting-stop determination unit determines whether the sorting-stop parameter of the channel transformation matrix is greater than or equal to the sorting-stop threshold. The memory records at least the sorting-stop parameter, the sorting-stop threshold, elements of the first processing unit set, elements of the second processing unit set, and the elements of the channel transformation matrix. The processor executes at least the sorting-stop parameter generating unit, the sorting-stop threshold generating unit, and the sorting-stop determination unit and moves the processing units between the first processing unit set and the second processing unit set.

According to an exemplary embodiment consistent with the present disclosure, the MIMO detector further includes a SNR generating unit for generating a SNR. The SNR is obtained according to a pilot signal with a constant signal strength received by the receiver from the transmitter. When the sorting-stop parameter is the SNR of the MIMO communication system, the sorting-stop threshold is a predetermined SNR threshold.

According to an exemplary embodiment consistent with the present disclosure, the MIMO detector further includes an eigenvalue spread generator for generating an eigenvalue spread value. The eigenvalue spread value represents a spread of a plurality of eigenvalues of the channel transformation matrix in the MIMO communication system, and the eigenvalue spread value is also a variance of the eigenvalues of the channel transformation matrix. When the sorting-stop parameter is the eigenvalue spread value, the sorting-stop threshold is a predetermined eigenvalue spread threshold, and the sorting-stop threshold is greater than 0.

As described above, in exemplary embodiments consistent with the present invention, a sorted QR decomposition method used in a detection of a MIMO antenna system and a detector using the sorted QR decomposition method are provided. In the sorted QR decomposition method, the energy required by the QR decomposition, the current SNR of the MIMO communication system, and the eigenvalue spread of a channel transformation matrix are used as sorting-stop thresholds in the QR decomposition. Besides, in the sorted QR decomposition method, the energy transferring action and the sorting action can be performed to the channel transformation matrix simultaneously through different processing units.

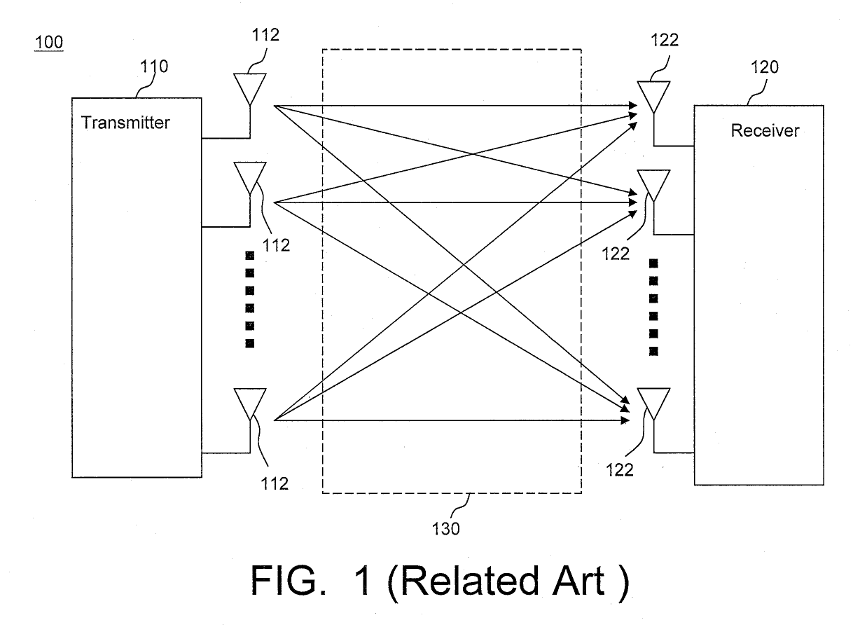

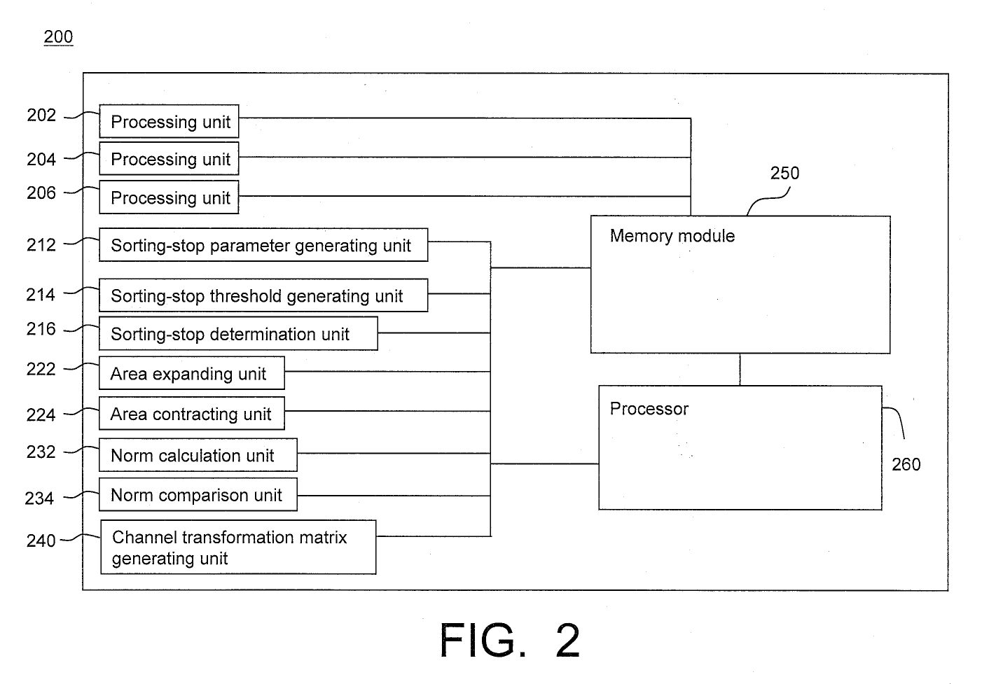

FIG. 2 is a system block diagram of a MIMO detector using a sorted QR decomposition method according to an exemplary embodiment of the present disclosure. First, referring to FIG. 2, the receiver 120 in FIG. 1 includes the MIMO detector 200. The MIMO detector 200 includes a processing module (not shown), a sorting module (not shown), an area processing module (not shown), a norm processing module (not shown), a channel transformation matrix generating unit 240, a memory module 250, and a processor 260.

Referring to FIG. 2 again, in the exemplary embodiment, the processing module includes processing units 202-206. However, the present disclosure is not limited thereto, and the processing module may have more than three processing units. The processing units 202-206 perform a sorting action and an energy transferring action to the channel transformation matrix 130 in FIG. 1. The channel transformation matrix 130 is obtained by the channel transformation matrix generating unit 240 by receiving a predetermined training sequence from the transmitter 110.

The processing units 202-206 may be digital signal processors or general hardware processors. However, the processing units 202-206 may also be implemented as software processing units. In the exemplary embodiment, the processing units 202-206 are grouped into a first processing unit set and a second processing unit set. The first processing unit set performs the energy transferring action to the channel transformation matrix 130, and the second processing unit set performs the sorting action to the channel transformation matrix 130.

The energy transferring action includes transferring the energy of the elements in a leftmost column to another element within a unit process area of each processing unit in the first processing unit set of the channel transformation matrix 130. The energy transferring action can be implemented with a givens rotation regarding matrix calculations. On the other hand, the sorting action includes sorting all columns within a second process area of the channel transformation matrix 130 according to a norm of each of the columns, wherein the column having the smallest norm is arranged as the leftmost column, and the column having the greatest norm is arranged as the rightmost column.

Initially, the second process area of the channel transformation matrix 130 is equal to the first process area of the channel transformation matrix 130, and the first process area includes all the elements of the channel transformation matrix. However, along with the processing units 202-206 continuously performing the sorting action and the energy transferring action to the channel transformation matrix 130, the first process area and the second process area are gradually contracted to the bottom right corner of the channel transformation matrix 130, and the first process area and the second process area may be contracted at different speeds.

Referring to FIG. 2, in the exemplary embodiment, originally the processing units 202-206 are all grouped to the first processing unit set, and the second processing unit set is an empty set. When one of the processing units in the first processing unit set is idle, the processor 260 moves the idle processing unit to the second processing unit set. When there is only one processing unit in the first processing unit set and the energy of the elements in the leftmost column within the second process area has been completely transferred to the top element in the leftmost column, the processor 260 moves all the processing units in the second processing unit set to the first processing unit set.

Referring to FIG. 2, in the exemplary embodiment, the sorting module includes a sorting-stop parameter generating unit 212, a sorting-stop threshold generating unit 214, and a sorting-stop determination unit 216. The sorting-stop parameter generating unit 212 generates a sorting-stop parameter according to a condition of the processing units 202-206 performing the sorting action and the energy transferring action to the channel transformation matrix 130. The sorting-stop parameter is a sum of the number of rows within the second process area of the channel transformation matrix 130 that energy of the elements in these rows is to be transferred to a diagonal element of the channel transformation matrix 130. The sorting-stop threshold generating unit 214 obtains the sorting-stop threshold through following equation (6):

X=(N−i)/2 Equation (6)

In foregoing equation (6), X is the sorting-stop threshold, N is the row number of the channel transformation matrix 130, and i is the index of a column in the channel transformation matrix to which the energy transferring action is current performed. Foregoing equation (6) is only an example for generating the sorting-stop threshold, and the present disclosure is not limited thereto. In different wireless communication systems, other mathematical equations may also be used for generating the sorting-stop threshold according to different operation variables and environment variables. Besides, the sorting-stop determination unit 216 determines with the second process area whether the sorting-stop parameter of the channel transformation matrix is greater than or equal to the sorting-stop threshold.

Referring to FIG. 2 again, in the exemplary embodiment, the area processing module includes an area expanding unit 222 and an area contracting unit 224. The area expanding unit 222 expands a unit process area (not shown) of the processing units 202-206. The area contracting unit 224 contracts the first process area and the second process area, and determines whether the first processing unit set has reached the element at the bottom right corner of the channel transformation matrix 130 according to a condition of the processing units 202-206 processing the channel transformation matrix 130. When energy of the elements in the leftmost column within the second process area has been completely transferred to the top element in the leftmost column, the area contracting unit 224 contracts the second process area toward the bottom right corner by one column and one row, and the area contracting unit 224 moves all the processing units in the second processing unit set to the first processing unit set. If the energy of the elements in the leftmost column within the second process area has not been completely transferred to the top element in the leftmost column, the area expanding unit 222 expands a unit process area of the processing units in the first processing unit set on the leftmost column within the second process area, and the area contracting unit 224 contracts the first process area toward the bottom right corner by one column and one row.

Referring to FIG. 2, in the exemplary embodiment, the norm processing module (not shown) includes a norm calculation unit 232 and a norm comparison unit 234. As described above, in the sorting action, the column having the smallest norm is arranged as the leftmost column, and the column having the greatest norm is arranged as the rightmost column. Thus, the processing units 202-206 calculate the norm of each column within the first process area through the norm calculation unit 232, and the norms of the columns within the first process area are compared through the norm comparison unit 234.

Referring to FIG. 2, in the exemplary embodiment, as described above, the channel transformation matrix generating unit 240 receives a predetermined training sequence through a plurality of receive antennas 122 of the receiver 120 from a plurality of transmit antennas 112 of the transmitter 110 to obtain the channel transformation matrix 130.

Referring to FIG. 2, in the exemplary embodiment, the memory module 250 records at least the sorting-stop parameter, the sorting-stop threshold, elements within the first process area, elements within the second process area, and the elements of the channel transformation matrix. In the exemplary embodiment, the memory module 250 stores a program module and data, wherein the program module and the data execute one or multiple processes for generating a program when they are executed by the processor 260. The memory module 250 may be one or multiple memory devices for storing data and software programs, and the memory module 250 may also be one or multiple random access memories (RAMs), magnetic storage devices, flash memory storage devices, or optical storage devices.

Referring to FIG. 2, in the exemplary embodiment, the processor 260 executes at least the sorting-stop parameter generating unit, the sorting-stop threshold generating unit and the sorting-stop determination unit, and also moves the processing units between the first processing unit set and the second processing unit set. The processor 260 may be implemented as one or multiple processors which are configured to execute the program module. The processor 260 may be one or multiple processor devices or may include a calculation logic processor or a digital signal processor.

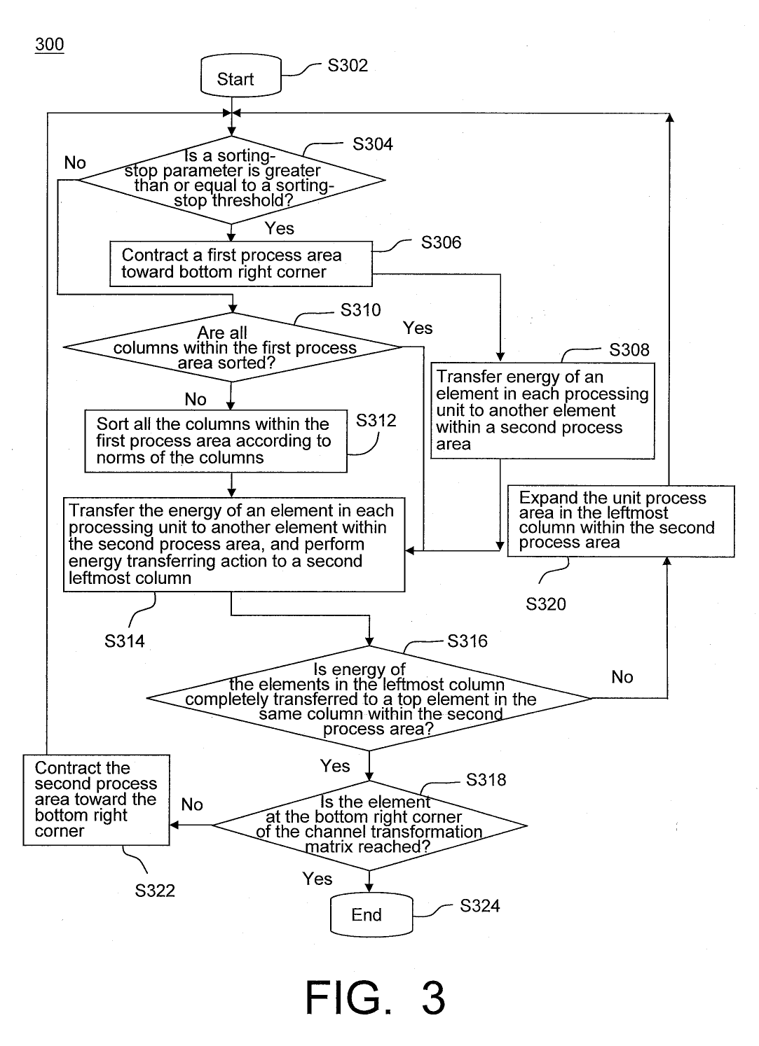

FIG. 3 is a flowchart of a sorted QR decomposition method according to the first exemplary embodiment of the present disclosure. Referring to both FIG. 2 and FIG. 3, in step S302, the sorted QR decomposition method 300 starts to process the channel transformation matrix. Step S304 is executed after step S302.

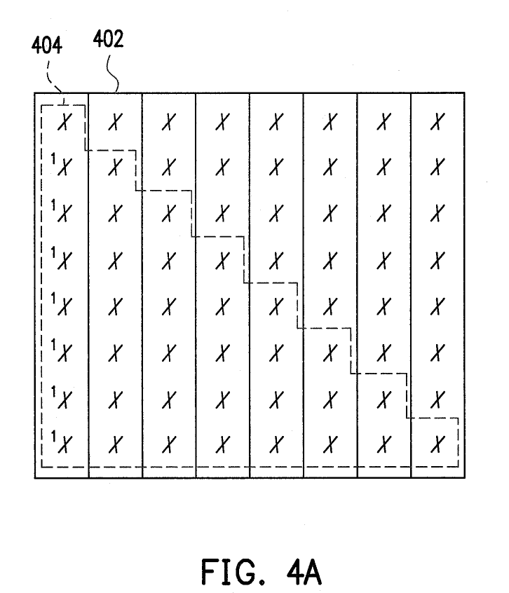

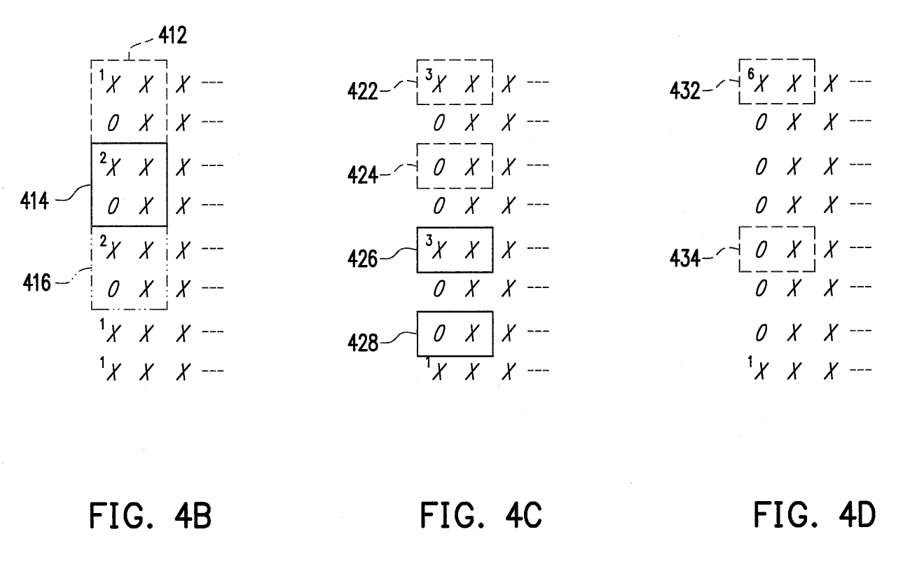

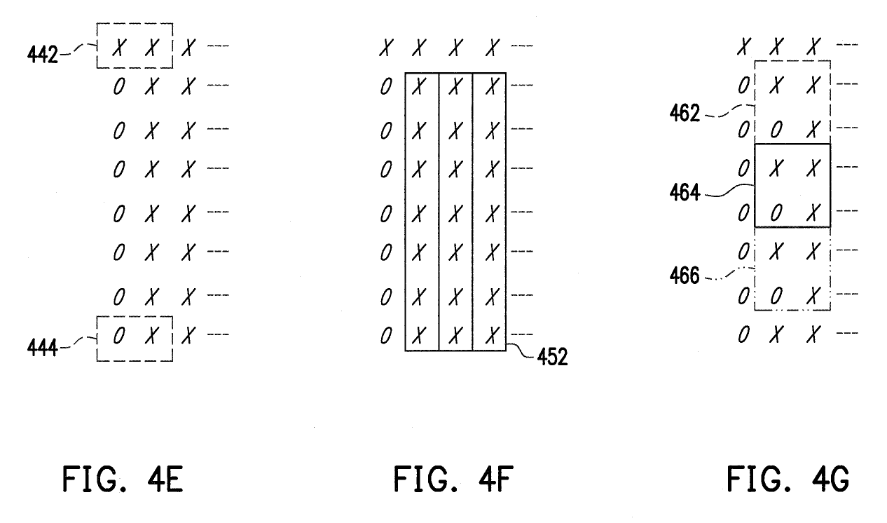

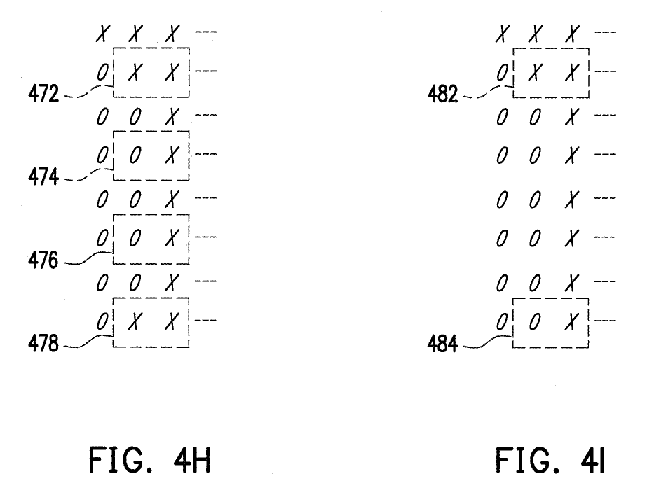

FIG. 4 illustrates the processing states of the sorted QR decomposition method in the channel transformation matrix. In the exemplary embodiment, the channel transformation matrix is originally an 8×8 matrix, as shown in FIG. 4A. In the sorted QR decomposition method 300, the process area 402 of the channel transformation matrix is defined as a first process area, and a process area 404 of the channel transformation matrix is defined as a second process area (as the process area enclosed by the dotted line in FIG. 4A). Initially, the first process area includes all the elements of the channel transformation matrix, and the second process area includes all the elements within a bottom left triangular area of the channel transformation matrix.

In step S304, the sorting-stop determination unit 216 determines whether the sorting-stop parameter of the channel transformation matrix is greater than or equal to the sorting-stop threshold with the first process area. If the sorting-stop parameter of the channel transformation matrix is greater than or equal to the sorting-stop threshold, step S306 is executed. If the sorting-stop parameter of the channel transformation matrix is less than the sorting-stop threshold, step S310 is executed after step S304.

In step S306, the area contracting unit 224 contracts the first process area toward the bottom right corner of the first process area by one column and one row. Step S308 is executed after step S306.

In step S308, the processing units in the first processing unit set transfer energy of an element within a unit process area of each processing unit to another element within the first process area. Step S314 is executed after step S308.

In step S310, the first processing unit set or the second processing unit set determines whether all columns are sorted within the first process area. If all the columns within the first process area have been sorted, step S312 is executed after step S310. If not all the columns within the first process area are sorted, step S314 is executed after step S310.

In step S312, the processing units in the first processing unit set perform the sorting action to all the columns within the first process area according to the norm of each of the columns within the second process area. The columns within the first process area are arranged from left to right, wherein the column having the smallest norm is arranged as the leftmost column, and the column having the greatest norm is arranged as the rightmost column. If the second processing unit set is currently an empty set, the processing units in the first processing unit set perform the sorting action to all the columns within the first process area. Step S314 is executed after step S312.

In step S314, the processing units in the first processing unit set transfer energy of an element in each processing unit to another element within the second process area and perform the energy transferring action to a second leftmost column. Step S316 is executed after step S314.

In step S316, the processing units in the first processing unit set determine whether the energy of the elements in the leftmost column within the second process area has been completely transferred to the top element in the leftmost column. If the energy of the elements in the leftmost column within the second process area has been completely transferred to the top element in the leftmost column, step S318 is executed. Otherwise, step S320 is executed. Step S304 is executed after step S316.

In step S318, the area reducing unit 224 checks whether the first processing unit set has reached the element at the bottom right corner of the channel transformation matrix within the second process area. If the first processing unit set has reached the element at the bottom right corner of the channel transformation matrix, step S324 is executed after step S318. If the first processing unit set has not reached the element at the bottom right corner of the channel transformation matrix, step S324 is executed after step S318.

In step S320, the area expanding unit 222 expands the unit process area of each processing unit in the first processing unit set on the leftmost column within the second process area. Step S304 is executed after step S320.

In step S322, the area contracting unit 224 contracts the first process area toward the bottom right corner by one column and one row. Step S304 is executed after step S322. The sorted QR decomposition method 300 terminates at step S324.

FIG. 4A-FIG. 4I illustrate the processing states of a sorted QR decomposition method with idle processing units in a channel transformation matrix. As shown in FIG. 2 and FIG. 4A, in the exemplary embodiment, the channel transformation matrix is originally an 8×8 matrix, as shown in FIG. 4A. In a general sorted QR decomposition method, the sorting action and the energy transferring action are performed to the elements of the channel transformation matrix from left to right, as shown in FIG. 4A-FIG. 4I, so as to transform the channel transformation matrix into a matrix whose elements within a bottom right triangular area are 0. In FIG. 4A, the three processing units 202, 204, and 206 perform the sorting action to all the columns of the channel transformation matrix. Next, in a general sorted QR decomposition method, the three processing units 202, 204, and 206 respectively perform the energy transferring action to the elements within the unit process areas 412, 414, and 416, as shown in FIG. 4B. In FIG. 4C, the area expanding unit 222 expands the process areas of the processing unit 202 and the processing unit 204. At this time, the processing unit 206 does not perform any action. Afterwards, in FIG. 4D, there is just the processing unit 202 performing the energy transferring action, and the processing units 202 and 204 do not perform any action. Thereafter, in FIG. 4E, because currently, the energy of the elements in the leftmost column has been completely transferred to the top element in the leftmost column, the area contracting unit 224 contracts the second process area toward the bottom right corner by one column and one row. Similarly, in following FIG. 4F-FIG. 4I, the processing units 202, 204, and 206 perform the sorting action and the energy transferring action within a continuously contracted area. As shown in FIG. 4B-FIG. 4I, some of the processing units may become idle at some times. According to the present invention, processing units in different sets respectively and simultaneously perform the energy transferring action and the sorting action when some of the processing units are idle.

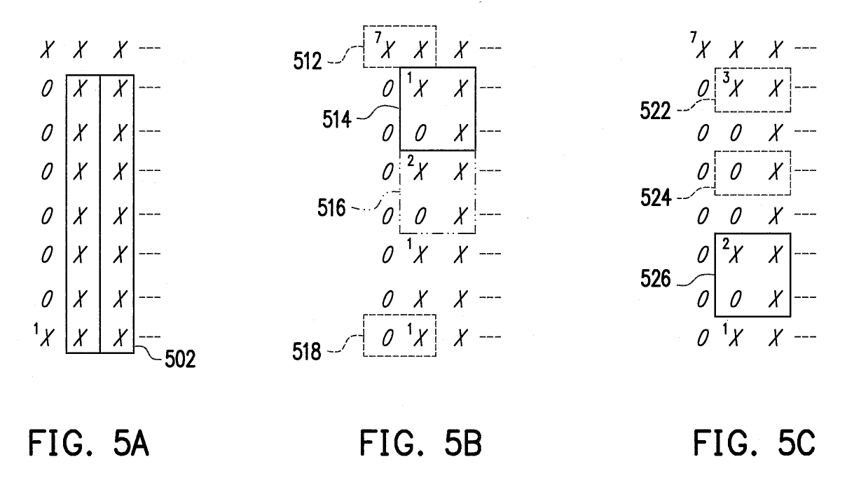

FIG. 5A-FIG. 5C illustrate the processing states of a sorted QR decomposition method without idle processing unit in a channel transformation matrix. As shown in FIG. 2 and FIG. 5A-FIG. 5C, in the exemplary embodiment, when the processing units in different processing unit sets respectively and simultaneously perform the energy transferring action and the sorting action, the processing units 202-206 are grouped into two sets, and the two sets respectively perform the sorting action and the energy transferring action simultaneously. In FIG. 5A, when the processing unit 202 is still performing the energy transferring action to the elements in the leftmost column within the second process area, the processing units 204 and 206 perform the sorting action in advance within the contracted first process area (the area 502). In FIG. 5B, after the sorting action is performed to the area 502, the processing units 204 and 206 respectively perform the energy transferring action to the unit process area 514 and the unit process area 516. In FIG. 5C, after the processing unit 202 finishes its action to the leftmost column, the processing unit 202 performs the energy transferring action to the unit process areas 522 and 524, and the processing unit 204 performs the energy transferring action to the unit process area 526. Meanwhile, the processing unit 206 performs the sorting action within the contracted first process area in advance. Accordingly, when one of the processing units 202-206 becomes idle, the idle processing unit is moved to perform the sorting action within the first process area in advance.

Besides the sorted QR decomposition method 300 and the MIMO detector 200 which use two processing unit sets to perform the sorting action and the energy transferring action at the same time, a sorted QR decomposition method and a MIMO detector which use a signal-to-noise ratio (SNR) value as the sorting-stop parameter or an eigenvalue spread of the channel transformation matrix as the sorting-stop parameter are provided in another exemplary embodiment of the present disclosure.

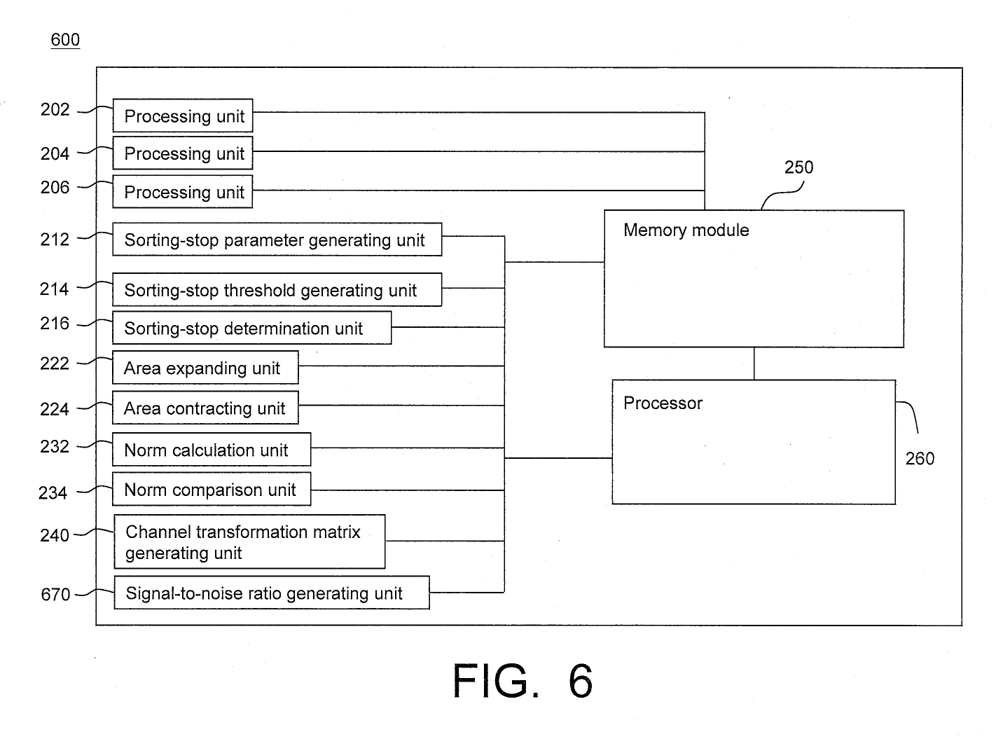

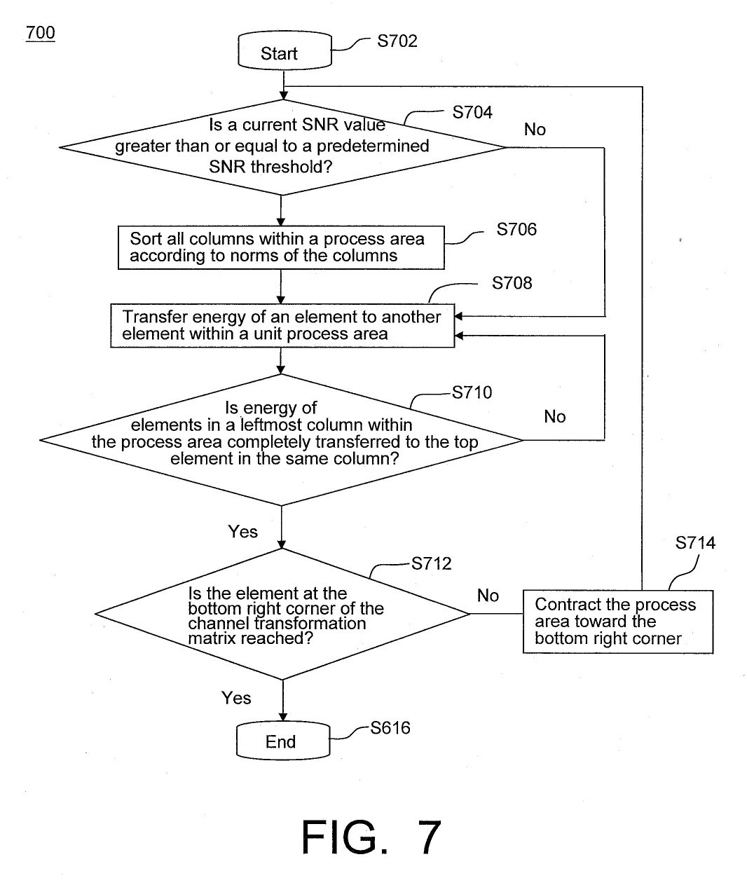

FIG. 6 is a system block diagram of a MIMO detector using a sorted QR decomposition method according to an exemplary embodiment of the present disclosure. The MIMO detector 600 is similar to the MIMO detector 200 illustrated in FIG. 2 and the similar part between the two will not be described herein. The difference between the two MIMO detectors 200 and 600 is that the MIMO detector 600 further includes a signal-to-noise (SNR) generating unit 670, and the sorting-stop threshold generating unit just records a predetermined SNR threshold but does not calculate the sorting-stop threshold. The SNR generating unit 670 generates a SNR value. The SNR value is obtained according to a pilot signal with a constant signal strength received by the receiver 120 from the transmitter 110. In the exemplary embodiment, the MIMO detector 600 uses the SNR value as the sorting-stop parameter and the sorting-stop threshold is a predetermined SNR threshold.

FIG. 7 is a flowchart of a sorted QR decomposition method according to the exemplary embodiment of the present disclosure. In the sorted QR decomposition method 700 of the second exemplary embodiment, when the sorting action is stopped is determined according to the SNR value.

In step S702, the sorted QR decomposition method 700 starts to process the channel transformation matrix 130. Step S704 is executed after step S702.

In step S704, the sorting-stop determination unit 216 determines whether the sorting-stop parameter of the channel transformation matrix is greater than or equal to the sorting-stop threshold within a process area (not shown). To be more specific, the sorting-stop determination unit 216 determines whether the SNR value generated by the SNR generating unit 670 is greater than or equal to a SNR threshold within the process area. If the SNR value is greater than or equal to the SNR threshold, step S706 is executed after step S704. If the SNR is less than the SNR threshold, step S708 is executed after step S704.

In step S706, the processing units perform the sorting action to all the columns within the process area according to the norm of each of these columns. All the columns within the process area are sorted from left to right, wherein the column having the smallest norm is arranged as the leftmost column, and the column having the greatest norm is arranged as the rightmost column. Step S708 is executed after step S706.

In step S708, the processing units transfer energy of an element within a unit process area to another element. Step S710 is executed after step S708.

In step S710, the processing units determine whether the energy of the elements in the leftmost column within a process area (not shown) has been completely transferred to a top element in the leftmost column. If the energy of the elements in the leftmost column within the process area has been completely transferred to the top element in the leftmost column, step S712 is executed after step S710. Otherwise, step S708 is executed after step S710.

In step S712, the area contracting unit 224 checks whether the processing units 202-206 have reached the element at the bottom right corner of the channel transformation matrix within the process area. If the processing units have not reached the element at the bottom right corner of the channel transformation matrix, step S714 is executed. If the processing units have reached the element at the bottom right corner of the channel transformation matrix, step S716 is executed and the sorted QR decomposition method 700 terminates at step S716.

In step S714, the area contracting unit 224 contracts the process area toward the bottom right corner by one column and one row. Step S704 is executed after step S714.

In the exemplary embodiment, the SNR threshold is, for example, 18 decibel. This SNR threshold is obtained with a K-best detector, a 16-QAM modulator, a channel transformation matrix with real number elements, and with 4×4 MIMO through repeated simulations. The 18 decibel is just an example of the SNR threshold but not for limiting the present invention. In different wireless communication systems, the SNR threshold may also adopt other values according to different operation variables or environment variables.

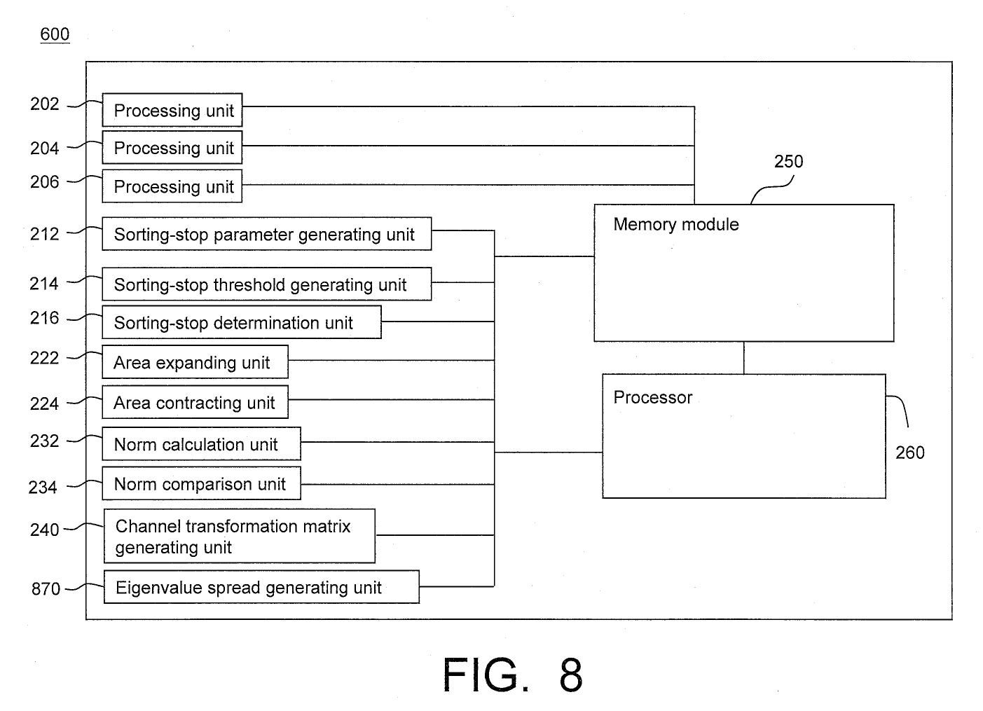

FIG. 8 is a system block diagram of a MIMO detector using a sorted QR decomposition method according to an exemplary embodiment of the present disclosure. The MIMO detector 800 is similar to the MIMO detector 200 illustrated in FIG. 2, and the similar part will not be described herein. The difference between the two MIMO detectors 200 and 800 is that the MIMO detector 800 includes an eigenvalue spread generating unit 870, and the sorting-stop threshold generating unit just records a predetermined eigenvalue spread threshold but does not calculate the sorting-stop threshold. The eigenvalue spread generating unit 870 generates an eigenvalue spread value according to the channel transformation matrix. The eigenvalue spread value represents a spread value of a plurality of eigenvalues of the channel transformation matrix, and the eigenvalue spread value is obtained through following equation (7):

ES=E{|x−E{x}|²} Equation (7)

In foregoing equation (7), ES is the eigenvalue spread, x is one of the eigenvalues of the channel transformation matrix, function E is an expected value function, function ∥ is an absolute value function, and the eigenvalue spread value is also a variance of the eigenvalues of the channel transformation matrix. In the second exemplary embodiment, the MIMO detector 800 uses the SNR as the sorting-stop parameter, and the sorting-stop threshold is a predetermined eigenvalue spread threshold.

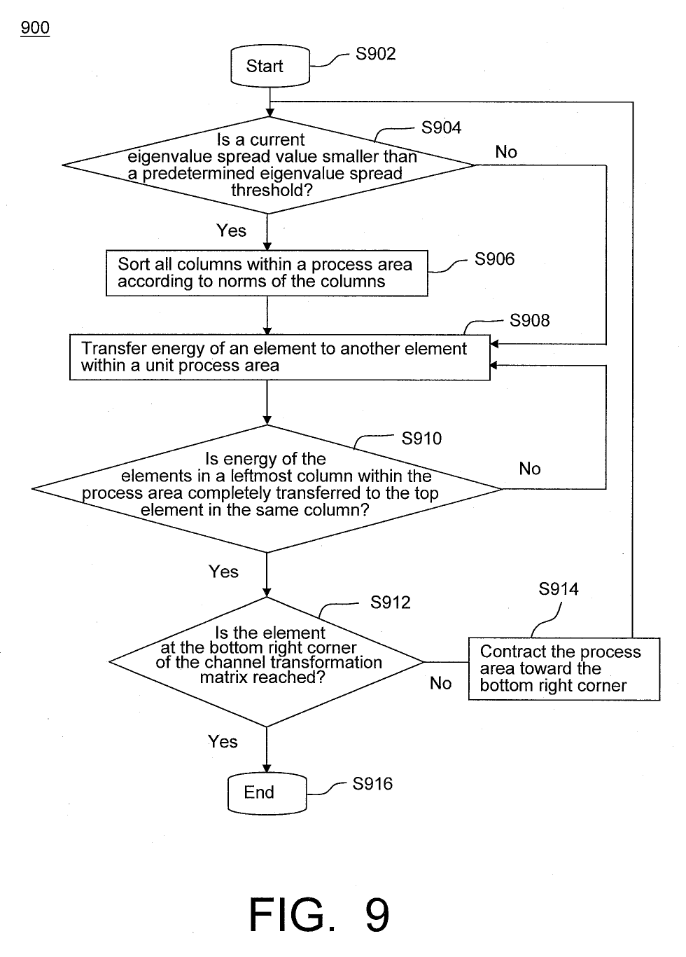

FIG. 9 is a flowchart of a sorted QR decomposition method according to the exemplary embodiment of the present disclosure. In the sorted QR decomposition method 900 of the exemplary embodiment, when the sorting action is stopped is determined according to the eigenvalue spread value.

The sorted QR decomposition method 900 is similar to the sorted QR decomposition method 700 illustrated in FIG. 7, and the similar part will not be described herein. The difference between the two sorted QR decomposition methods 700 and 900 falls on step S904.

In step S904, the sorting-stop determination unit 216 determines whether the eigenvalue spread value of the channel transformation matrix is less than the eigenvalue spread threshold within a process area. If the eigenvalue spread is less than the eigenvalue spread threshold, step S906 is executed after step S904. If the eigenvalue spread value is greater than or equal to the eigenvalue spread threshold, step S908 is executed after step S904.

In the exemplary embodiment, the eigenvalue spread threshold is, for example, 0.5. This eigenvalue spread threshold is obtained with a K-best detector, a 16-QAM modulator or a 64-QAM modulator, a channel transformation matrix with real number elements, and 4×4 MIMO through repeated simulations. However, the present disclosure is not limited thereto, and in different wireless communication systems, the eigenvalue threshold may adopt other values according to different operation variables or environment variables.

Apart from foregoing three exemplary embodiments consistent with the present disclosure, another two embodiments of the present disclosure are further described below. These two embodiments are respectively developed based on the exemplary embodiment described above. However, in another exemplary embodiment, when the sorting action is stopped is determined according to the SNR value, and in the fifth exemplary embodiment, when the sorting action is stopped is determined according to the eigenvalue spread value of the channel transformation matrix.

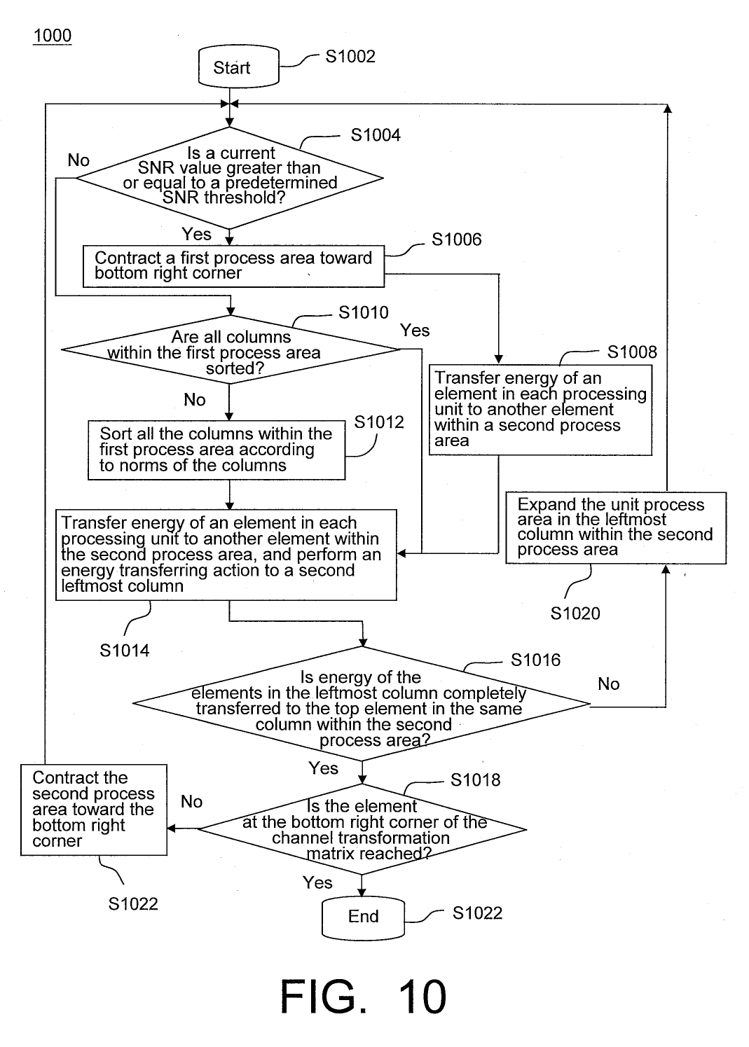

FIG. 10 is a flowchart of a sorted QR decomposition method according to an exemplary embodiment of the present disclosure. In the sorted QR decomposition method 1000 of the exemplary embodiment, when the sorting action is stopped is determined according to the SNR value, and as illustrated in the exemplary embodiment, two processing unit sets are adopted for respectively performing the sorting action and the energy transferring action simultaneously.

The sorted QR decomposition method 1000 is similar to the sorted QR decomposition method 300 illustrated in FIG. 3, and the similar part will not be described herein. The difference between the two sorted QR decomposition methods 300 and 1000 falls on step S1004.

In step S1004, the sorting-stop determination unit 216 determines whether the SNR value generated by the SNR generating unit 670 is greater than or equal to the SNR threshold within the first process area. If the SNR value is greater than or equal to the SNR threshold, step S1006 is executed after step S1004. If the SNR is less than the SNR threshold, step S1010 is executed after step S1004. The exemplary embodiment will be described below, wherein when the sorting action is stopped is determined according to the eigenvalue spread value of the channel transformation matrix.

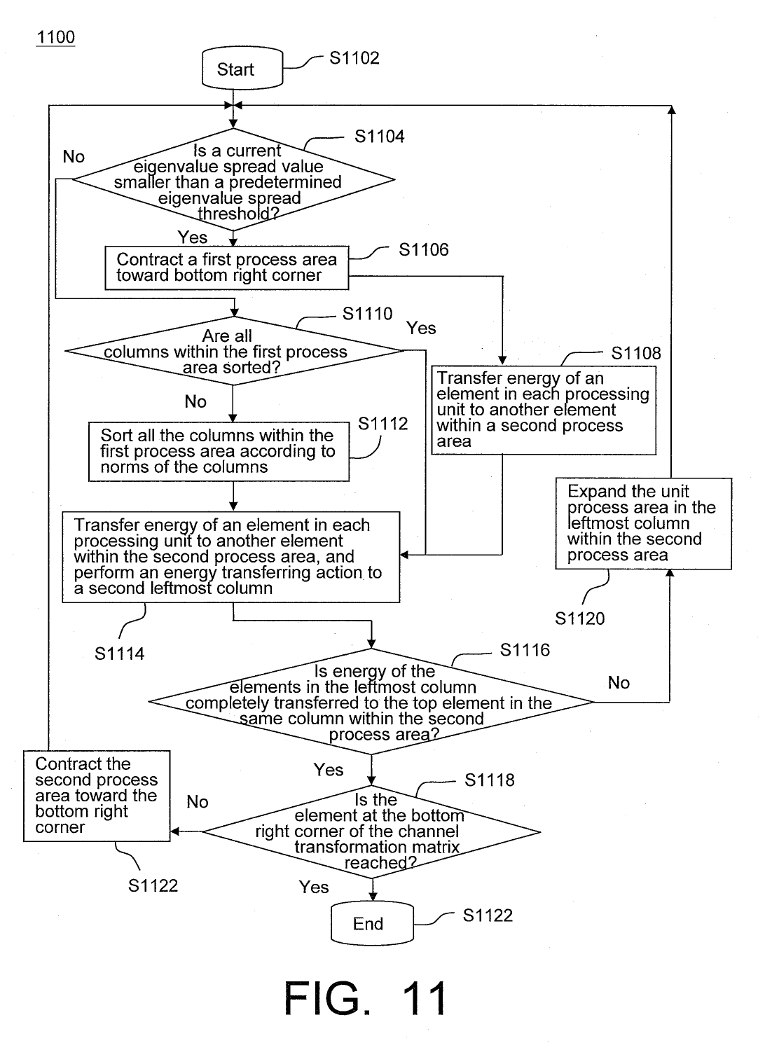

FIG. 11 is a flowchart of a sorted QR decomposition method according to an exemplary embodiment of the present disclosure. In the sorted QR decomposition method 1100 of the fifth exemplary embodiment, when the sorting action is stopped is determined according to the eigenvalue spread value of the channel transformation matrix, and as illustrated in the exemplary embodiment, two processing unit sets are adopted for respectively performing the sorting action and the energy transferring action simultaneously.

The sorted QR decomposition method 1100 is similar to the sorted QR decomposition method 300 illustrated in FIG. 3, and the similar part will not be described herein. The difference between the two sorted QR decomposition methods 300 and 1100 falls on step S1104.

In step S1104, the sorting-stop determination unit 216 determines whether the eigenvalue spread value generated by the eigenvalue spread generating unit 870 is less than the eigenvalue spread threshold within the first process area. If the eigenvalue spread value generated by the eigenvalue spread generating unit 870 is less than the eigenvalue spread threshold, step S1106 is executed after step S1104. If the eigenvalue spread generated by the eigenvalue spread generating unit 870 is greater than or equal to the eigenvalue spread threshold, step S1110 is executed after step S1104.

In summary, in exemplary embodiments of the present disclosure, a sorted QR decomposition method used in a detection of a MIMO antenna system and a detector using the same are provided, wherein two processing unit sets are adopted for respectively performing a sorting action and an energy transferring action to a channel transformation matrix simultaneously, and when the sorting action is stopped is determined according to a SNR value or an eigenvalue spread value of the channel transformation matrix.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sorted QR decomposition method, used in a detection of a multiple input multiple output (MIMO) communication system, wherein a receiver of the MIMO communication system receives a predetermined training sequence from a transmitter to obtain a channel transformation matrix, the channel transformation matrix has a plurality of elements, each of the elements represents a channel response parameter between one of a plurality of transmit antennas and one of a plurality of transmit antennas, and the receiver has a plurality of processing units, the sorted QR decomposition method comprising:
determining whether a sorting-stop parameter of the channel transformation matrix is greater than or equal to a sorting-stop threshold, wherein the sorting-stop parameter is a sum of rows within a first process area that energy of the elements in the rows is to be transferred to a diagonal element of the channel transformation matrix; and
determining whether energy of the elements in a leftmost column within a second process area of the channel transformation matrix is completely transferred to a top element in the leftmost column, and if the energy of the elements in the leftmost column within the second process area of the channel transformation matrix is not completely transferred to the top element in the leftmost column, a unit process area of a first processing unit set in the processing units is expanded in the leftmost column within the second process area of the channel transformation matrix.

2. The sorted QR decomposition method as claimed in claim 1, wherein after determining whether the sorting-stop parameter of the channel transformation matrix is greater than or equal to the sorting-stop threshold, the sorted QR decomposition method further comprises:
if the sorting-stop parameter within the first process area is less than the sorting-stop threshold, determining whether all the columns within the first process area are sorted, and
if all the columns within the first process area are sorted, performing a sorting action within the first process area through a second processing unit set according to a norm of each of the columns within the first process area, wherein the first processing unit set performs the sorting action within the second process area if the second processing unit set is an empty set; and
if not all the columns within the first process area are sorted, performing an energy transferring action to the leftmost column within the second process area through the processing units in the first processing unit set, and meanwhile, performing the energy transferring action to a second leftmost column within the second process area, and performing the sorting action within the first process area through the second processing unit set according to the norms of the columns within the first process area; and
if the sorting-stop parameter within the first process area is greater than or equal to the sorting-stop threshold, contracting the first process area toward a bottom right corner of the first process area.

3. The sorted QR decomposition method as claimed in claim 2, wherein after determining whether the energy of the elements in the leftmost column within the second process area of the channel transformation matrix is completely transferred to the top element in the leftmost column, the sorted QR decomposition method further comprises:
determining whether the first processing unit set reaches the element at a bottom right corner of the channel transformation matrix, and contracting the second process area toward a bottom right corner of the second process area if the first processing unit does not reach the element at the bottom right corner of the channel transformation matrix.

4. The sorted QR decomposition method as claimed in claim 2, wherein after performing the sorting action within the first process area through the second processing unit set, the sorted QR decomposition method further comprises:
performing the energy transferring action to the leftmost column within the second process area through each of the processing units in the first processing unit set.

5. The sorted QR decomposition method as claimed in claim 1, wherein the sorting action comprises:
sorting all the columns according to the norms of the columns, wherein the column having a smallest norm is arranged as the leftmost column, and the column having a largest norm is arranged as a rightmost column.

6. The sorted QR decomposition method as claimed in claim 1, wherein,
a transmitter of the MIMO communication system has K transmit antennas, wherein K is a positive integer;
the receiver of the MIMO communication system has L receive antennas, wherein L is a positive integer;
the channel transformation matrix is a L×K matrix, wherein the channel transformation matrix has L rows and K columns; and
each of the elements of the channel transformation matrix represents a channel response parameter between one of the K transmit antennas and one of the L transmit antennas.

7. The sorted QR decomposition method as claimed in claim 1, wherein the first process area of the channel transformation matrix originally comprises all the elements of the channel transformation matrix, and the second process area of the channel transformation matrix originally comprises all the elements within a bottom left triangular area of the channel transformation matrix.

8. The sorted QR decomposition method as claimed in claim 1 further comprising:
when one of the processing units in the first processing unit set is idle, moving the idle processing unit to the second processing unit; and
when there is just one processing unit in the first processing unit set and the energy of the elements in the leftmost column within the second process area is completely transferred to the top element in the leftmost column, moving all the processing units in the second processing unit set to the first processing unit set.

9. The sorted QR decomposition method as claimed in claim 1, wherein,
the sorting-stop threshold is obtained through an equation X=(N−i)/2, wherein X is the sorting-stop threshold, N is a sum of the number of rows in the channel transformation matrix, and i is an index of a column in the channel transformation matrix to which the energy transferring action is currently performed.

10. A computer-readable storage medium, for storing a program, wherein the program executes the sorted QR decomposition method in claim 1.

11. A sorted QR decomposition method, used in a detection of a MIMO communication system, wherein a receiver of the MIMO communication system receives a predetermined training sequence from a transmitter to obtain a channel transformation matrix, the channel transformation matrix has a plurality of elements, each of the elements represents a channel response parameter between one of a plurality of transmit antennas and one of a plurality of transmit antennas, and the receiver has a plurality of processing units, the sorted QR decomposition method comprising:
determining whether a sorting-stop parameter of the channel transformation matrix is greater than or equal to a sorting-stop threshold,
if the sorting-stop parameter of the channel transformation matrix is greater than or equal to the sorting-stop threshold, performing a sorting action to all columns within a process area through the processing units according to a norm of each of the columns within the process area; and
if the sorting-stop parameter of the channel transformation matrix is less than the sorting-stop threshold, transferring energy of an element in a leftmost column within a unit process area of each of the processing units to another element in the same column.

12. The sorted QR decomposition method as claimed in claim 11, wherein after determining whether the sorting-stop parameter of the channel transformation matrix is greater than or equal to the sorting-stop threshold, the sorted QR decomposition method further comprises:
if the sorting-stop parameter of the channel transformation matrix is greater than or equal to the sorting-stop threshold, performing the sorting action to all the columns within the process area through the processing units according to the norm of each of the columns within the process area; and
if the sorting-stop parameter of the channel transformation matrix is less than the sorting-stop threshold, transferring energy of an element in a leftmost column within the unit process area of each of the processing units in a first processing unit set to another element in the same column through the processing units.

13. The sorted QR decomposition method as claimed in claim 11, wherein,
the sorting-stop parameter is a signal-to-noise ratio value of the MIMO communication system, wherein
the signal-to-noise ratio value is obtained according to a pilot signal with a constant signal strength received by the receiver from the transmitter; and
when the sorting-stop parameter is the signal-to-noise ratio value, the sorting-stop threshold is a predetermined signal-to-noise ratio threshold.

14. The sorted QR decomposition method as claimed in claim 11, wherein,
the sorting-stop parameter is an eigenvalue spread value, wherein the eigenvalue spread value represents a spread value of a plurality of eigenvalues of the channel transformation matrix of the MIMO communication system, and the eigenvalue spread value is obtained through following equation (1):
ES=E{|x−E{x}|²} Equation (1),
wherein ES is the eigenvalue spread value, x is one of the eigenvalues of the channel transformation matrix, function E is an expectation value function, function ∥ is an absolute value function, and the eigenvalue spread is also a variance of the eigenvalues of the channel transformation matrix; and
when the sorting-stop parameter is the eigenvalue spread value, the sorting-stop threshold is a predetermined eigenvalue spread threshold, and the sorting-stop threshold is greater than 0.

15. The sorted QR decomposition method as claimed in claim 11, wherein the sorting action comprises:
sorting all the columns according to the norm of each of the columns, wherein the column having a smallest norm is arranged as a leftmost column, and the column having a greatest norm is arranged as a rightmost column.

16. The sorted QR decomposition method as claimed in claim 11 further comprising:
determining whether energy of the elements in a leftmost column within the process area is completely transferred to a top element in the leftmost column, and
if the energy of the elements in the leftmost column within the process area is not completely transferred to the top element in the leftmost column, the energy of an element in the leftmost column within the unit process area of each of the processing units is transferred to another element in the same column; and
if the energy of the elements in the leftmost column within the process area is completely transferred to the top element in the leftmost column, whether the first processing unit set reaches the element at a bottom right corner of the channel transformation matrix is determined.

17. The sorted QR decomposition method as claimed in claim 16, wherein after determining whether the first processing unit set reaches the element at the bottom right corner of the channel transformation matrix, the sorted QR decomposition method further comprises:
determining whether the first processing unit set reaches the element at the bottom right corner of the channel transformation matrix, and
if the first processing unit set does not reach the element at the bottom right corner of the channel transformation matrix, contracting the process area toward the bottom right corner of the process area by one column and one row, and determining whether the sorting-stop parameter of the channel transformation matrix is greater than or equal to the sorting-stop threshold.

18. A sorted QR decomposition method, used in a detection of a MIMO communication system, wherein a receiver of the MIMO communication system receives a predetermined training sequence from a transmitter to obtain a channel transformation matrix, the channel transformation matrix has a plurality of elements, each of the elements represents a channel response parameter between one of a plurality of transmit antennas and one of a plurality of transmit antennas, and the receiver has a plurality of processing units, the sorted QR decomposition method comprising:
determining whether a sorting-stop parameter of the channel transformation matrix is greater than or equal to a sorting-stop threshold; and
determining whether energy of the elements in a leftmost column within a first process area of the channel transformation matrix is completely transferred to a top element in the leftmost column, and
if the energy of the elements in the leftmost column within the first process area of the channel transformation matrix is not completely transferred to the top element in the leftmost column, a unit process area of a first processing unit set in the processing units is expanded in the leftmost column within the first process area of the channel transformation matrix.

19. The sorted QR decomposition method as claimed in claim 18, wherein after determining whether the sorting-stop parameter of the channel transformation matrix is greater than or equal to the sorting-stop threshold, the sorted QR decomposition method further comprises:
if the sorting-stop parameter within the first process area is greater than or equal to the sorting-stop threshold, contracting the first process area toward a bottom right corner of the first process area, and performing an energy transferring action to a leftmost column within a second process area the processing units in the first processing unit set; and
if the sorting-stop parameter within the first process area is less than the sorting-stop threshold, determining whether all the columns within the second process area are sorted.

20. The sorted QR decomposition method as claimed in claim 19, wherein after determining whether the energy of the elements in the leftmost column within the first process area of the channel transformation matrix is completely transferred to the top element in the leftmost column, the sorted QR decomposition method further comprises:
determining whether the first processing unit set reaches the element at a bottom right corner of the channel transformation matrix, and contracting the first process area toward a bottom right corner of the first process area if the first processing unit set does not reach the element at the bottom right corner of the channel transformation matrix.

21. The sorted QR decomposition method as claimed in claim 19, wherein after determining whether all the columns within the second process area are sorted, the sorted QR decomposition method further comprises:
if all the columns within the second process area are sorted, performing a sorting action within the first process area through the second processing unit set according to a norm of each of the columns within the first process area, wherein the first processing unit set performs the sorting action within the first process area if the second processing unit set is an empty set; and
if not all of the columns within the second process area are sorted, performing the energy transferring action to a leftmost column within the first process area through the processing units in the first processing unit set, and meanwhile, performing the energy transferring action to a second leftmost column within the first process area, and performing the sorting action within the second process area through the second processing unit set according to the norm of each of the columns within the second process area.

22. The sorted QR decomposition method as claimed in claim 18, wherein the sorting action comprises:
sorting all the columns according to the norm of each of the columns, wherein the column having a smallest norm is arranged as a leftmost column, and the column having a greatest norm is arranged as a rightmost column.

23. The sorted QR decomposition method as claimed in claim 18, wherein the second process area of the channel transformation matrix originally comprises all the elements of the channel transformation matrix, and the first process area of the channel transformation matrix originally comprises all the elements within a bottom left triangular area of the channel transformation matrix.

24. The sorted QR decomposition method as claimed in claim 18 further comprising:
when one of the processing units in the first processing unit set is idle, moving the idle processing unit to the second processing unit set; and
when there is just one processing unit in the first processing unit set and the energy of the elements in the leftmost column within the first process area is completely transferred to the top element in the leftmost column, moving all the processing units in the second processing unit set to the first processing unit set.

25. The sorted QR decomposition method as claimed in claim 18, wherein,
the sorting-stop parameter is a signal-to-noise ratio value of the MIMO communication system, wherein the signal-to-noise ratio value is obtained according to a pilot signal with a constant signal strength received by the receiver from the transmitter; and
when the sorting-stop parameter is the signal-to-noise ratio value, the sorting-stop threshold is a predetermined signal-to-noise ratio threshold.

26. The sorted QR decomposition method as claimed in claim 18, wherein
the sorting-stop parameter is an eigenvalue spread value, wherein the eigenvalue spread value represents a spread value of a plurality of eigenvalues of the channel transformation matrix of the MIMO communication system, and the eigenvalue spread value is obtained through following equation (1):
ES=E{|x−E{x}|²} Equation (1),
wherein ES is the eigenvalue spread, x is one of the eigenvalue of the channel transformation matrix, function E is an expectation value function, function ∥ is an absolute value function, and the eigenvalue spread value is also a variance of the eigenvalues of the channel transformation matrix; and
when the sorting-stop parameter is the eigenvalue spread value, the sorting-stop threshold is a predetermined eigenvalue spread threshold, and the sorting-stop threshold is greater than 0.

27. A detector, suitable for using a QR decomposition method for a detection of a MIMO antenna system, wherein the MIMO communication system has a channel transformation matrix, a transmitter and a receiver, the channel transformation matrix has a plurality of elements, and each of the elements represents a channel response parameter between one of a plurality of transmit antennas and one of a plurality of transmit antennas, the detector comprising:
a plurality of processing units, for performing at least a sorting action and an energy transferring action to the channel transformation matrix, wherein the processing units are grouped into a first processing unit set and a second processing unit set;
a sorting-stop parameter generating unit, for generating a sorting-stop parameter, wherein the sorting-stop parameter is a sum of the number of rows within a first process area of the channel transformation matrix that energy of the elements in the rows is to be transferred to a diagonal element of the channel transformation matrix;
a sorting-stop threshold generating unit, for calculating a sorting-stop threshold through an equation X=(N−i)/2, wherein X is the sorting-stop threshold, N is a sum of the number of all rows of the channel transformation matrix, and i is an index of a column in the channel transformation matrix to which the energy transferring action is currently performed;
a sorting-stop determination unit, for determining whether the sorting-stop parameter of the channel transformation matrix is greater than or equal to the sorting-stop threshold;
a memory, for recording at least the sorting-stop parameter, the sorting-stop threshold, the elements within the first process area, the elements within a second process area, and the elements of the channel transformation matrix; and
a processor, for executing at least the sorting-stop parameter generating unit, the sorting-stop threshold generating unit, and the sorting-stop determination unit, and for moving the processing units between the first processing unit set and the second processing unit set.

28. The detector as claimed in claim 27, wherein the processing units further comprise:
a norm calculation unit, for calculating a norm of each of the columns within the first process area;
a norm comparison unit, for comparing the norms of the columns within the first process area;
the first processing unit set, for executing the energy transferring action to the channel transformation matrix, wherein the energy transferring action comprises transferring the energy of an element in a leftmost column within a unit process area of each of the processing units in the first processing unit set to another element; and
the second processing unit set, for executing the sorting action to the channel transformation matrix, wherein the sorting action comprises sorting all the columns within the first process area according to a norm of each of the columns, wherein the column having a smallest norm is arranged as a leftmost column, and the column having a greatest norm is arranged as a rightmost column.

29. The detector as claimed in claim 27 further comprising:
an area contracting unit, for recording the first process area, contracting the second process area, and determining whether the first processing unit set reaches the element at a bottom right corner of the channel transformation matrix;
an area expanding unit, for expanding the unit process area of each of the processing units; and
a channel transformation matrix generating unit, for obtaining the channel transformation matrix by receiving a predetermined training sequence from the transmitter.

30. The detector as claimed in claim 29, wherein,
the sorting-stop determination unit determines whether the sorting-stop parameter within a first process area of the channel transformation matrix is greater than or equal to a sorting-stop threshold; and
the first processing unit set determines whether energy of the elements in a leftmost column within the second process area of the channel transformation matrix is completely transferred to the top element in the leftmost column, and
if the energy of the elements in the leftmost column within the second process area of the channel transformation matrix is not completely transferred to the top element in the leftmost column, the area expanding unit expands the unit process area of the first processing unit set in the leftmost column within the second process area of the channel transformation matrix.

31. The detector as claimed in claim 30, wherein,
if the sorting-stop parameter within the first process area is greater than or equal to the sorting-stop threshold, the area contracting unit contracts the first process area toward the bottom right corner of the first process area; and
if the sorting-stop parameter within the first process area is less than the sorting-stop threshold, the first processing unit set further determines whether all the columns within the first process area are sorted, and
if all the columns within the first process area are sorted, the second processing unit set performs the sorting action within the first process area according to the norm of each of the columns within the first process area, wherein the first processing unit set performs the sorting action within the second process area if the second processing unit set is an empty set; and
if not all the columns within the first process area are sorted, the processing units in the first processing unit set perform the energy transferring action to the leftmost column within the second process area, and meanwhile, perform the energy transferring action to a second leftmost column within the second process area, and the second processing unit set performs the sorting action within the first process area.

32. The detector as claimed in claim 30, wherein when the area contracting unit determines that the first processing unit set does not reach the element at the bottom right corner of the channel transformation matrix, the area contracting unit contracts the second process area toward a bottom right corner of the second process area by one column and one row.

33. The detector as claimed in claim 30, wherein the detector further performs the energy transferring action to the leftmost column within the second process area through the processing units in the first processing unit set.

34. The detector as claimed in claim 30, wherein if the area contracting unit determines that the second process area is contracted to the element at the bottom right corner of the channel transformation matrix, the processing units in the first processing unit set stop the energy transferring action, and the processing units in the second processing unit set stop the sorting action.

35. The detector as claimed in claim 27, wherein the first process area of the channel transformation matrix originally comprises all the elements of the channel transformation matrix, and the second process area of the channel transformation matrix originally comprises all the elements within a bottom left triangular area of the channel transformation matrix.

36. The detector as claimed in claim 27, wherein,
when one of the processing units in the first processing unit set is idle, the processor moves the idle processing unit to the second processing unit set; and
when there is just one processing unit in the first processing unit set and the energy of the elements in the leftmost column within the second process area is completely transferred to the top element in the leftmost column, the processor moves all the processing units in the second processing unit set to the first processing unit set.

37. A detector, suitable for using a QR decomposition method for a detection of a MIMO antenna system, wherein the MIMO communication system has a channel transformation matrix, a transmitter and a receiver, the channel transformation matrix has a plurality of elements, and each of the elements represents a channel response parameter between one of a plurality of transmit antennas and one of a plurality of transmit antennas, the detector comprising:
a plurality of processing units, for performing at least a sorting action and an energy transferring action to the channel transformation matrix, wherein the processing units are grouped into a first processing unit set and a second processing unit set;
a sorting-stop parameter generating unit, for generating a sorting-stop parameter;
a sorting-stop threshold generating unit, for generating a sorting-stop threshold;
a sorting-stop determination unit, for determining whether the sorting-stop parameter of the channel transformation matrix is greater than or equal to the sorting-stop threshold;
a memory, for recording at least the sorting-stop parameter, the sorting-stop threshold, the elements in the first processing unit set, the elements in the second processing unit set, and the elements of the channel transformation matrix; and
a processor, for executing at least the sorting-stop parameter generating unit, the sorting-stop threshold generating unit, and the sorting-stop determination unit, and for moving the processing units between the first processing unit set and the second processing unit set.

38. The detector as claimed in claim 37 further comprising:
an area contracting unit, for contracting the first process area and contracting a second process area, and for determining whether the first processing unit set reaches the element at a bottom right corner of the channel transformation matrix;
an area expanding unit, for expanding the unit process area of each of the processing units;
a channel transformation matrix generating unit, for obtaining the channel transformation matrix by receiving a predetermined training sequence from the transmitter; and
the processing units comprising:
a norm calculation unit, for calculating a norm of each of columns within the first process area;
a norm comparison unit, for comparing the norms of the columns within the first process area;
the first processing unit set, for executing the energy transferring action to the channel transformation matrix, wherein the energy transferring action comprises transferring the energy of an element in a leftmost column within a unit process area of each of the processing units in the first processing unit set to another element; and
the second processing unit set, for executing the sorting action to the channel transformation matrix, wherein the sorting action comprises sorting all the columns within the first process area according to the norms of the columns, wherein the column having a smallest norm is arranged as a leftmost column, and the column having a greatest norm is arranged as a rightmost column.

39. The detector as claimed in claim 38, wherein,
the sorting-stop determination unit determines whether the sorting-stop parameter within a first process area of the channel transformation matrix is greater than or equal to a sorting-stop threshold; and
the first processing unit set determines whether the energy of the elements in a leftmost column within the second process area of the channel transformation matrix is completely transferred to a top element in the leftmost column, and if the energy of the elements in the leftmost column within the second process area of the channel transformation matrix is not completely transferred to the top element in the leftmost column, the area expanding unit expands the unit process area of the first processing unit set in the leftmost column within the second process area of the channel transformation matrix.

40. The detector as claimed in claim 39, wherein,
if the sorting-stop parameter within the first process area is greater than or equal to the sorting-stop threshold, the area contracting unit contracts the first process area toward a bottom right corner of the first process area; and
if the sorting-stop parameter within the first process area is less than the sorting-stop threshold, the first processing unit set further determines whether all the columns within the first process area are sorted;
if all the columns within the first process area are sorted, the second processing unit set performs the sorting action within the first process area according to a norm of each of the columns within the first process area, wherein the first processing unit set performs the sorting action within the second process area if the second processing unit set is an empty set; and
if not all the columns within the first process area are sorted, each of the processing units in the first processing unit set performs the energy transferring action to a leftmost column within the second process area, and meanwhile, performs the energy transferring action to a second leftmost column within the second process area, and the second processing unit set performs the sorting action within the first process area.

41. The detector as claimed in claim 39, wherein when the area contracting unit determines that the first processing unit set does not reach the element at a bottom right corner of the channel transformation matrix, the area contracting unit contracts the second process area toward a bottom right corner of the second process area by one column and one row.

42. The detector as claimed in claim 39, wherein the detector further performs the energy transferring action to the leftmost column within the second process area through each of the processing units in the first processing unit set.

43. The detector as claimed in claim 37, wherein if the area contracting unit determines that the first process area is contracted to the element at the bottom right corner of the channel transformation matrix, the processing units of the first processing unit set stop the energy transferring action, and the processing units in the second processing unit set stop the sorting action.

44. The detector as claimed in claim 39, wherein the first process area of the channel transformation matrix comprises all the elements of the channel transformation matrix, and the second process area of the channel transformation matrix comprises all the elements in a bottom left triangular area of the channel transformation matrix.

45. The detector as claimed in claim 37, wherein,
when one of the processing units in the first processing unit set is idle, the processor moves the idle processing unit to the second processing unit set; and
when there is just one processing unit in the first processing unit set and the energy of the elements in the leftmost column within the first process area is completely transferred to the top element in the leftmost column, the processor moves all the processing units in the second processing unit set to the first processing unit set.

46. The detector as claimed in claim 37 further comprising:
a signal-to-noise ratio generating unit, for generating a signal-to-noise ratio value, wherein
when the signal-to-noise ratio value is obtained according to a pilot signal with a constant signal strength received by the receiver from the transmitter,
when the sorting-stop parameter is the signal-to-noise ratio value, the sorting-stop threshold is a predetermined signal-to-noise ratio threshold.

47. The detector as claimed in claim 37 further comprising:
an eigenvalue spread generator, for generating an eigenvalue spread value, wherein the eigenvalue spread value represents a spread value of a plurality of eigenvalues of the channel transformation matrix of the MIMO communication system, and the eigenvalue spread value is obtained through following equation (1):
ES=E{|x−E{x}|²} Equation (1),
wherein ES is the eigenvalue spread, x is one of the eigenvalues of the channel transformation matrix, function E is an expectation value function, function ∥ is an absolute value function, and the eigenvalue spread value is also a variance of the eigenvalues of the channel transformation matrix; and
when the sorting-stop parameter is the eigenvalue spread value, the sorting-stop threshold is a predetermined eigenvalue spread threshold, and the sorting-stop threshold is greater than 0.
